(19) United States
(12) Patent Application Publication
(10) Pub. No.: US 2021/0182655 A1
(43) Pub. Date: Jun. 17, 2021

(54) ROBUST RECURRENT ARTIFICIAL NEURAL NETWORKS

(71) Applicant: INAIT SA, Lausanne (CH)

(72) Inventors: Henry Markram, Pully (CH); Felix Schürmann, Grens (CH); Daniel Milan Lütgehetmann, Lausanne (CH); John Rahmon, Lausanne (CH)

(21) Appl. No.: 16/710,266

(22) Filed: Dec. 11, 2019

(51) Int. Cl. G06N 3/04; G06N 3/08

(52) U.S. Cl. CPC G06N 3/0481; G06N 3/08

(57) ABSTRACT

Robust recurrent artificial neural networks and techniques for improving the robustness of recurrent artificial neural networks. For example, a system can include a plurality of nodes and links arranged in a recurrent neural network, wherein either transmissions of information along the links or decisions at the nodes are non-deterministic, and an output configured to output indications of occurrences of topological patterns of activity in the recurrent artificial neural network.

### TECHNICAL FIELD

This invention relates to recurrent artificial neural networks, and more particularly to robust recurrent artificial neural networks and techniques for improving the robustness of recurrent artificial neural networks.

### BACKGROUND

Artificial neural networks are devices that are inspired by the structure and functional aspects of networks of biological neurons. In particular, artificial neural networks mimic the information encoding and other processing capabilities of networks of biological neurons using a system of interconnected constructs called nodes. The arrangement and strength of connections between nodes in an artificial neural network determines the results of information processing or information storage by the artificial neural network.

In general, robustness is the ability to tolerate a certain amount of loss or error but yet still perform meaningful operations. For example, robust signal transmission conveys information even if, e.g., bits are lost during transmission. As another example, a robust communications network can transmit information even if certain nodes or communication lines are rendered inoperable.

The operations that are performed after a loss need not be “perfect” or identical to the operations that are performed in the absence of a loss. Rather, a system or device can undergo “graceful degradation” whereby it will continue to operate—albeit at reduced capacity—even the event of a fault in some of its components. This contrasts with devices and systems that suffer disproportionally large errors and/or undergo catastrophic failure and cease to operate altogether in the event of a fault.

### SUMMARY

Robust recurrent artificial neural networks and approaches for improving the robustness of recurrent artificial neural networks are described.

In a general sense, the robustness of a recurrent artificial neural network can be increased by increasing the “entanglement” of information storage, transmission, and processing within the neural network. Entanglement in this context refers to the distribution of functionality across different elements of the recurrent artificial neural network. Each part of the recurrent artificial neural network contains some of the functionality of other parts. In this sense, “entanglement” does merely provide multiple, discrete copies or versions of identical functionality. Although such redundancy does indeed improve robustness (e.g., in techniques like RAID coding), entanglement in the present context refers to a recurrent artificial neural network structure that acts as an integrated whole and performs operations using interoperable multiple elements. Since the elements operate together, any one element is only a small part of the larger whole. A fault in any one element will not render the recurrent artificial neural network wholly inoperable. Rather, the operations performed by the recurrent artificial neural network may merely degrade and depart from ideality.

In a first aspect, a system includes a plurality of nodes and links arranged in a recurrent neural network, wherein either transmissions of information along the links or decisions at the nodes are non-deterministic, and an output configured to output indications of occurrences of topological patterns of activity in the recurrent artificial neural network.

In a second aspect, a system includes a plurality of nodes and links arranged in a recurrent neural network, wherein each node is coupled to output signals to between 10 and 10\hat{ }6 other nodes and to receive signals from between 10 and 10\hat{ }6 other nodes, and an output configured to output indications of occurrences of topological patterns of activity in the recurrent artificial neural network.

In a third aspect, a system includes a plurality of nodes and links arranged in a recurrent neural network, wherein at least some pairs of nodes are linked by multiple connections, and an output configured to output indications of occurrences of topological patterns of activity in the recurrent artificial neural network.

In a fourth aspect, a system includes a plurality of nodes and links arranged in a recurrent neural network, wherein the recurrent neural network includes background activity that is not dependent on input data, and an output configured to output indications of occurrences of topological patterns of activity in the recurrent artificial neural network.

Each of the first through fourth aspects, and other aspects, can include one or more of the following features. The decision thresholds of the nodes can have a degree of randomness. The recurrent neural network can include background activity that is not dependent on input data. Either a timing of signal arrival at a destination node or a signal amplitude at the destination node can have the degree of randomness. At least some pairs of nodes can be linked by multiple links. The system can include an application trained to process the indications of the occurrences of topological patterns of activity. The application can have been trained using non-deterministic output from the recurrent artificial neural network. The topological patterns of activity can be clique patterns of activity. Each node can be coupled to output signals to between 10\hat{ }3 and 10\hat{ }5 other nodes and to receive signals from between 10\hat{ }3 and 10\hat{ }5 other nodes. Each of the links can be configured to convey information that is encoded in a number of nearly identical signals transmitted within a given time. The transmission of information along the links can be non-deterministic. At least some pairs of nodes can be linked by multiple links. The multiple connections can include multiple excitatory links. For example, the multiple excitatory links can include between 2 and 20 excitatory links. The multiple connections can include multiple inhibitory links. For example, the multiple inhibitory links can include between 5 and 40 links. The multiple connections can be configured to convey a same signal but ensure that the signal arrives at a destination node at different times. The multiple connections can be configured to convey a same signal but with a degree of randomness in the conveyance of the signal. Either a timing of signal arrival at a destination node or a signal amplitude at the destination node can have the degree of randomness. The multiple connections can include a single link that conveys information in accordance with a model of multiple links. Either transmissions of information along the links or decisions at the nodes can be non-deterministic. At least some pairs of nodes can be linked by multiple connections. For example, the multiple connections can include between 3 and 10 links excitatory links. As another example, the multiple connections comprise between 10 and 30 inhibitory links. Each node can be coupled to output signals to between 10\hat{ }3 and 10\hat{ }5 other nodes and to receive signals from between 10\hat{ }3 and 10\hat{ }5 other nodes.

Corresponding methods and machine-readable media are also possible.

The details of one or more embodiments of the invention are set forth in the accompanying drawings and the description below. Other features and advantages will be apparent from the description and drawings, and from the claims.

### DESCRIPTION OF DRAWINGS

FIG. 1 is a schematic representation of an implementation of an artificial neural network system that includes a relatively robust recurrent neural network.

FIG. 2 is a schematic representation of a minute portion of a recurrent neural network.

FIG. 3 is schematic representation of another minute portion of a recurrent neural network.

FIGS. 4 and 5 are representations of patterns of activity that can be identified and read from a recurrent neural network.

FIG. 6 is a schematic representation of a determination of the timing of activity patterns that have a distinguishable complexity.

FIG. 7 is a schematic representation of an implementation of a relatively robust artificial neural network system.

FIG. 8 is a schematic representation of an approach for inputting data that originates from different sensors into a recurrent neural network.

Like reference symbols in the various drawings indicate like elements.

### DETAILED DESCRIPTION

FIG. 1 is a schematic representation of an implementation of an artificial neural network system 100 that includes a relatively robust recurrent neural network. Neural network system 100 includes a collection of network inputs 105, a recurrent neural network 110, a collection of network outputs 115. In some cases, neural network inputs 105 receive data that originates from a variety of diverse sensors such as, e.g., transducers that convert different physical properties into data or devices that sense only certain types of data, such as, e.g., a device that senses the content of a document or data stream. Recurrent neural network 110 processes and abstracts even such diverse input data into a common representation 120 that is output over outputs 115 and suitable for input into multiple, diverse applications. In this, recurrent neural network 110 resembles a biological brain in that even diverse input data (e.g., vision, sounds, smells) can be abstracted into a “universal representation” that is applied to different diverse applications and used for, e.g., movement, language, and/or further abstraction.

### Network Inputs 105

In more detail, in the illustrated implementation, inputs 105 are schematically represented as a well-defined input layer of nodes that each passively relay the input to one or more locations in neural network 110. However, this is not necessarily the case. For example, in some implementations, one or more of inputs 105 can scale, delay, phase shift or otherwise process some portion or all of the input data before data is conveyed to neural network 110. As another example, data may be injected into different layers and/or edges or nodes throughout neural network 110, i.e., without a formal input layer as such. For example, a user can specify that data is to be injected into specific nodes or links that are distributed throughout network 110. As another example, neural network 110 need not be constrained to receiving input in a known, previously defined manner (e.g., always injecting a first bit into a first node, the second bit into a second node, . . . etc.). Instead, a user can specify that certain bits in the data are to be injected into edges rather than nodes, that the order of injection need not follow the order that the bits appear, or combinations of these and other parameters. Nevertheless, for the sake of convenience, the representation of inputs 105 as an input layer will be maintained herein.

In some implementations, neural network 110 can receive data that originates from multiple, different sensors over inputs 105. The sensors can be, e.g., transducers that convert different physical properties into data or devices that sense only data, such as, e.g., a device that senses the content of a document or data stream. The data may not only originate from different sensors, but may also have different formats and/or characteristics. For example, certain classes of data (e.g., video or audio data) may change relatively rapidly in time or “stream,” whereas other classes of data (e.g., a still image or temperature) may change relatively slowly or not at all.

For example, the input data can include one or more of sound data that originates from, e.g., a microphone, still image data that originates from, e.g., a still camera, video data that originates from, e.g., a video camera, and temperature data that originates from, e.g., a temperature sensor. This is for illustrative purposes only. The input data can include one or more of a variety of other different types of data including, e.g., pressure data, chemical composition data, acceleration data, electrical data, position data, or the like. In some implementation, the input data can undergo one or more processing actions prior to input into neural network 110. Examples of such processing actions include, e.g., non-linear processing in an artificial neural network device.

### Recurrent Neural Network 110

In recurrent neural networks, the connections between nodes form a directed graph along a temporal sequence and the network exhibits temporal dynamic behavior. In some implementations, recurrent neural network 110 is a relatively complex neural network that is modelled on a biological system. In other words, recurrent neural network 110 can itself model a degree of the morphological, chemical, and other characteristics of a biological system. In general, recurrent neural networks 110 that are modelled on biological systems are implemented on one or more computing devices with a relatively high level of computational performance.

In contrast with, e.g., traditional feedforward neural networks, recurrent neural networks 110 that are modelled on biological systems may display background or other activity that is not responsive to input data. Indeed, activity may be present in such neural networks 110 even in the absence of input data. However, upon input of data, a recurrent neural network 110 will be perturbed. Since the response of such a neural network 110 to a perturbation may depend, in part, on the state of neural network 110 at the time that data is input, the response of such a neural network 110 to the input of data may also depend on the background or other activity that is already present in neural network 110. Nevertheless, even though such activity in a neural network is not responsive only to the input of data, it is responsive to input data.

The response of neural network 110 to the input data can be read as a collection of topological patterns. In particular, upon the input of data, neural network 110 will respond with a certain activity. That activity will include:
activity that does not comport with defined topological patterns, and
activity that does comport with defined topological patterns.

The activity in neural network 110 that does not comport with defined topological patterns can in some cases be incorrect or incomplete abstractions of the characteristics of the input data, or other operations on the input data. The activity in neural network 110 that does comport with topological patterns can abstract different characteristics of the input data. Each of the abstracted characteristics may be more or less useful depending on the application. By limiting representation 120 to representation of certain topological patterns, both incorrect or incomplete abstractions and abstraction of characteristics that are not relevant to a particular application can be “filtered out” and excluded from representation 120.

At times, neural network 110 will respond to the input of data that originates from different sensors with one or more topological patterns that are the same, even if other topological patterns are different. For example, neural network 110 may respond to either a temperature reading or a still image of a desert with a topological pattern that represents a qualitative assessment of “hot,” even if other topological patterns are also part of the response to each input. Similarly, neural network 110 can respond to the conclusion of a musical composition or a still image of a plate with crumbs with a topological pattern that represents a qualitative assessment of “done,” even if other topological patterns are also part of the response to each input. Thus, at times, the same characteristic may be abstracted from data that has different origins and different formats.

At times, neural network 110 will respond to the input of data that originates from different sensors with one or more topological patterns that represent the synthesis or fusion of the characteristics of the data from those sensors. In other words, a single such pattern can represent an abstraction of the same characteristic that is present in different types of data. In general, the fusion or synthesis of data from different sensors will act to cause such patterns to arise or the strength of the activity of such patterns to increase. In other words, data from different sensors can act as “corroborative evidence” that the same characteristic is present in the diverse input data.

In some cases, topological patterns that represent the synthesis or fusion of the characteristics of data from different sensors will only arise if certain characteristics are present in the data from different sensors. Neural network 110 can in effect act as an AND gate and require that certain characteristics in data from different sensors in order for certain patterns of activity to arise. However, this need not be the case. Instead, the magnitude of the activity that forms a pattern may increase or the timing of the activity may shorten in response to data from different sensors. In effect, the topological patterns of activity—and their representation in representation 120—represent abstractions of the characteristics of the input data in a very rich state space. In other words, the topological patterns of activity and their representation are not necessarily the predefined “results” of processing input data in the sense that, e.g., a yes/no classification is the predefined result yielded by a classifier, a set of related inputs is the predefined result yielded by a clustering device, or a prediction is the predefined result yielded by a forecasting model. Rather, the topological patterns are abstractions of the characteristics of the input data. Although that state space may at times include abstractions such as a yes/no classification, the state space is not limited to only those predefined results.

Further, the topological patterns may abstract characteristics of only a portion (e.g., a particular region of an image or a particular moment in a video or audio stream or a particular detail of the input such as a pixel) of the input data, rather than the entirety of the input data. Thus, the state space of the abstractions is neither limited to either a predefined type of result (e.g., a classification, a cluster, or a forecast), nor to abstractions of the entirety of the input data. Rather, the topological patterns are a tool that allows the processing by a high-dimensional, non-linear, recurrent dynamic system (i.e., neural network 110) to be read. The topological patterns extract correlates of the input data that arise in neural network 110, including correlates that fuse the data into a more complete “whole.” Further, by virtue of the recurrent nature of the neural network, the fusion occurs over time. As initial operations or abstractions are completed, the results of these initial operations or abstractions can be fused with other operations or abstractions that are completed at the same time or even later. The fusion thus occurs at a different, later time than the initial operations or abstractions.

Notwithstanding the different origins and formats, neural network 110 can still abstract characteristics from the data. For example, neural network 110 may abstract:
physical traits (e.g., color, shape, orientation, speed),
categories (e.g., car, cat, dog), and/or
abstract qualitative traits (e.g., “alive” vs. “dead,” “smooth” vs. “rough,” “animate” vs. “inanimate,” “hot” vs. “cold,” “open” vs. “closed”).

If one were to constrain input data to originating from a small number of sensors, it may be unlikely that neural network 110 would abstract the data from that sensor in certain ways. By way of example, it may be unlikely that neural network 110 would abstract temperature data by itself into a pattern of activity that corresponds to a spatial trait like shape or orientation. However, as data from different sensors is input into neural network 110, the perturbations provoked by diverse input data meet each other and can collectively influence the activity in neural network 110. As a result, the neural network 110 may abstract input data into different or more certain patterns of activity.

For example, there may be a degree of uncertainty associated with the presence or absence of a pattern. If the input data includes data from diverse range of sensors, both the diversity of the patterns and the certainty of the patterns may increase as the data that originates from different sensors is synthesized or fused within the neural network 110. By way of analogy, a passenger who is sitting in a train at a train station may look out the window and see an adjacent train that appears to be moving. That same passenger may also, e.g., feel forward pressure from the seat. The fusion or synthesis of this information increases the passenger's degree of certainty that the passenger's train is moving, rather than the adjacent train. When neural network receives diverse input data, the perturbations provoked by that data can collectively be abstracted into different or more certain patterns of activity.

The ability of neural network 110 to process input data from diverse sensors also provides a degree of robustness to the abstraction of that data. By way of example, one sensor of a group may become inaccurate or even inoperative and yet neural network 110 can continue to abstract data from the other sensors. Often, neural network 110 will abstract data from the other sensors into the same patterns of activity that would have arisen had all of the sensors been functioning as designed. However, in some instances, the certainty of those abstractions may decrease. Nevertheless, abstraction can continue even if such a problem should arise.

### Network Outputs 115 and Representation 120

The abstraction of data by neural network 110 can be read from outputs 115 as, e.g., a collection of (generally binary) digits that each represent the presence or absence of a respective topological pattern of activity in neural network 110 responsive to input data. In some case, each digit in representation 120 represents the presence or absence of a respective pattern of activity in neural network 110. Representation 120 is only schematically illustrated and representation 120 can be, e.g., one-dimensional vector of digits, a two-dimensional matrix of digits, or other collection of digits. In general, the digits in representation 120 will be binary and indicate in a yes/no manner whether a pattern of activity is present or not. However, this is not necessarily the case. Instead, in some implementations, the digits in representation 120 will be multi-valued. The values can denote characteristics of the presence or absence of a respective pattern of activity in neural network 110. For example, the values can indicate the strength of the activity or a statistical probability that a specific pattern of activity is in fact present. By way of example, activity that is relatively large in magnitude or that occurs within a relatively short window of time can be considered as indicating that a specific operation has been performed or was likely to have been performed. In contrast, activity that is relatively small in magnitude or that occurs over a relatively longer time can be considered less likely to indicating that a specific operation has been performed.

In any case, the responsive patterns of activity represent a specific operation performed by the neural network 110 on the input data. The operation can be arbitrarily complex. A single digit can thus encode an arbitrarily complex operation and a set of digits can convey a set of operations, each with an arbitrary level of complexity.

Further, the topological patterns of activity—and their representation in representation 120—can be “universal” in the sense that they are not dependent on the origin of the data being input into the neural network nor on the application to which representation 129 is applied. Rather, the topological patterns of activity express abstract characteristics of the data that is being input into neural network 110—regardless of the origins of that data.

Typically, multiple topological patterns of activity will arise in response to a single input, whether the input is discrete (e.g., a still photo or a single reading from a transducer that measures a physical parameter) or continuous (e.g., a video or an audio stream). The output representation 120 can thus represent the presence or absence topological structures that arise in the patterns of activity responsive to the input data even in a relatively complex recurrent neural network that is modelled on biological systems.

In the illustrated implementation, outputs 115 are schematically represented as a multi-node output layer. However, outputs 115 need not be a multi-node output layer. For example, output nodes 115 can be individual “reader nodes” that identify occurrences of a particular pattern of activity at a particular collection of nodes in neural network 110 and hence read the output of neural network 110. The reader nodes can fire if and only if the activity at a particular collection of nodes satisfies timing (and possibly magnitude or other) criteria. For example, output nodes 115 can be connected to a collection of nodes in neural network 110 and indicate the presence or absence topological structures based on, e.g., the activity levels of each individual node crossing a respective threshold activation level, a weighted sum of the activity levels of those nodes crossing a threshold activation level, or a non-linear combination of the activity levels of those nodes crossing a threshold activation level.

The information in representation 120 is holographically represented in the sense that information about the value of a single digit is distributed across the values of other digits in the representation 120. In other words, random subsets of digits in representation 120 also contain information about the operations performed by the neural network 110 to input, just at lower resolution than would be present if all the digits in representation 120 were present. As discussed further below, different topological patterns have different degrees of complexity. Some relatively more complex patterns may include relatively less complex patterns. Further, simple patterns can be assembled to more complex patterns. Information about the occurrence of some topological patterns thus inherently includes some information about the occurrence of other topological patterns.

For the sake of convenience, the remainder of the application will refer to the representation 120 as a collection of binary bits and the FIGS. will illustrate them as such. However, it is to be understood that in all cases the digits of representation 120 can also be multi-valued to encode various aspects of the operations performed by the network.

As discussed above, the ability of recurrent neutral network 110 to process input data from diverse sensors also provides a degree of robustness to the abstraction of that data. Neutral network 110 is not exclusively reliant on any one type of data—or on any one type of data being correct. Further, the topological patterns that are output from neutral network 110 can fuse faulty input data (e.g., absent or inaccurate input data) with other, accurate input data. The resultant fusion may be inaccurate in some respects due to the faulty input data, but the accurate input data ensures that some level of accuracy remains.

Further, by virtue of the recurrent nature of the neural network, processing occurs over time. As initial operations or abstractions are completed, the results of these initial operations or abstractions combine with other operations or abstractions that are completed at the same time or even later. The recurrency of neutral network 110 in effect allows neutral network 110 to approach a result or a conclusion—as represented by a topological patterns—over time. A fault may disturb the processing within recurrent neural network 110 for a relatively brief period without disturbing all of the processing over time. If the processing that occurs over time is accurate, then a temporary disturbance may be overcome by longer duration operations of the recurrent neural network.

In addition to such factors that provide recurrent neutral network 110 with a degree of robustness, the links and nodes in recurrent neutral network 110 may be structured to improve robustness. In general, structuring that “entangles” the information storage, transmission, and processing within recurrent neutral network 110 will improve the robustness of neural network 110. In more detail, the nodes and links in recurrent neutral network 110 can act as the data processing units, i.e., receiving signals, determining the importance of the received signals, and outputting additional signals that represent the results of that processing. The interconnections between nodes in recurrent neutral network 110 can be structured to ensure that this data processing is widely distributed and robust even in the event of a fault.

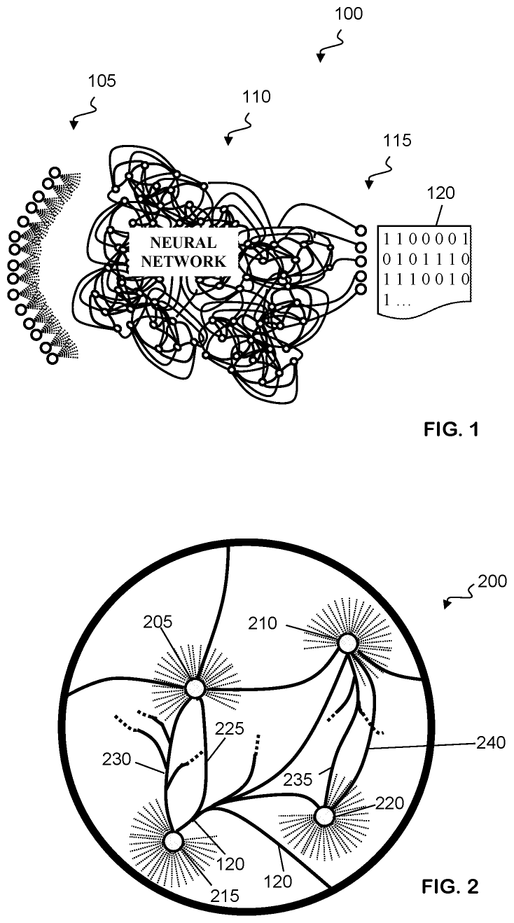

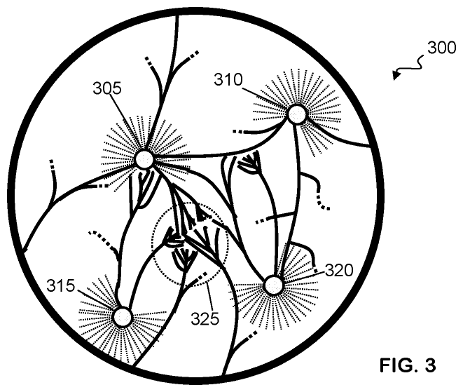

FIGS. 2 and 3 schematically illustrate example characteristics of the nodes and links in a recurrent neural network that can improve the robustness in a recurrent neural network. Although only a miniscule number of nodes and links are illustrated in each of the FIGS., the principles can be applied to recurrent neural networks with hundreds of millions if not hundreds of millions of nodes and links.

FIG. 2 is a schematic representation of a minute portion 200 of a recurrent neural network. Portion 200 includes a mere four nodes 205, 210, 215, 220. Nodes 205, 210, 215, 220 are interconnected by a collection of links. Further nodes 205, 210, 215, 220 are connected to other nodes in the recurrent neural network by additional links. For illustrative purposes, those additional links are represented as dashed lines.

There are several characteristics of links that can improve the robustness of a recurrent neural network. One example characteristic is a relatively large fan-out and/or large fan-in of the links that are connected to nodes 205, 210, 215, 220. In this context, fan-out is the number of nodes or links that receive input from a single output of a node or link. Fan-in is the number of inputs that a node or link receives. The large fan-in and fan-out are schematically illustrated by the dashed-line links discussed above.

In some implementations, a single node (e.g., each of nodes 205, 210, 215, 220) may output signals to between 10 and 10\hat{ }6 other nodes, for example, between 10\hat{ }3 and 10\hat{ }5 other nodes. In some implementations, a single node (e.g., each of nodes 205, 210, 215, 220) may receive signals from between 10 and 10\hat{ }6 other nodes, for example, between 10\hat{ }3 and 10\hat{ }5 other nodes. Such a relatively large fan-out leads to a very dramatic distribution of the results of processing by each node. Further, such a relatively large fan-in allows each node to based processing on input that originates from a legion of different nodes. Any particular fault—be it in the input data or the nodes and links within the recurrent neural network itself—is unlikely to lead to catastrophic failure.

Another example characteristic that can improve the robustness of a recurrent neural network is the non-linear transmission of information within the neural network. For example, the links in neural network 110 can carry spike-like transmissions that carry information, e.g., based on the number of spikes within a given time. As another example, the nodes and links in neural network 110 can have non-linear activation functions, including activation functions that resemble the activation functions of biological neurons.

Another example characteristic that can improve the robustness of a recurrent neural network are multi-link connections between individual nodes. In the schematic illustration, nodes 205, 215 are connected my multiple links 225, 230. Nodes 210, 220 are connected my multiple links 235, 240. In some cases, such multiple links may be purely redundant and convey the exact same information between the connected nodes in the exact same manner. However, in general, multiple links will not convey the exact same information in the exact same manner. For example, different processing results may be conveyed by different links. As another example, the multiple links may convey the same result such that the result arrives at the destination node at different times and/or with different consequences at the receiving node.

In some implementations, the links in a recurrent neural network can be either inhibitory or excitatory. Inhibitory links make it less likely that the receiving node outputs a particular signal whereas excitatory links make it more likely that the receiving node outputs a particular signal. In some implementations, nodes may be connected by multiple excitatory links (e.g., between 2 and 20 links or between 3 and 10 links). In some implementations, nodes may be connected by multiple inhibitory links (e.g., between 5 and 40 links or between 10 and 30 links).

Multi-link connections both provide a robust connectivity amongst the nodes and help avoid fully deterministic processing. As discussed further below, another characteristic that can contribute to robustness is non-deterministic transmission of information between nodes. Any particular fault—be it in the input data or the nodes and links within the recurrent neural network itself—is unlikely to lead to catastrophic failure because of the distributed transmission of non-deterministic information through multi-link connections.

Another example characteristic that can improve the robustness of a recurrent neural network is non-deterministic transmission between individual nodes. A deterministic system is a system that develops future states without randomness. For a given input, a deterministic system will always produce the same output. In the present context, non-deterministic transmission between nodes allows a degree of randomness in the signal that is transmitted to another node (or even output from the recurrent neural network) for a given set input data. The input data is not merely the data that is input to the recurrent neural network as a whole, but also encompasses the signals received by individual nodes within the recurrent neural network.

Such randomness can be introduced into the signal transmission in a variety of ways. For example, in some implementations, the behavior of nodes can be non-deterministic. Decision thresholds, time constants, and other parameters can be randomly varied to ensure that a given node does not respond identically to the same input signals at all times. As another example, the links themselves can be non-deterministic. For example, transmission times and amplitude attenuations can be randomly varied to ensure that a given link does not convey the same input signal identically at all times.

As yet another example, the behavior of the recurrent neural network as a whole can be non-deterministic and this behavior can impact the transmission of signals between nodes. For example, the recurrent neural network may display background or other activity that is not dependent on the input data, e.g., present even in the absence of input data. Such a background level of activity may lead to non-deterministic transmission between individual nodes even if the nodes and the links are themselves deterministically defined.

By introducing a degree of variability into the signal transmission, the processing within the recurrent neural network will inherently be tolerant of minor deviations. In particular, a recurrent neural network that can produce meaningful results notwithstanding a certain amount of variability in the signal transmission within the recurrent neural network will also be able to produce meaningful results if there is a fault—either in the input data or the nodes and links within the recurrent neural network itself. The performance of the recurrent neural network will degrade gracefully rather than catastrophically.

Further, not only the recurrent neural network itself, but also any application that processes the output of the recurrent neural network will tolerate a certain degree of variability. Since the recurrent neural network is non-deterministic, the output responsive to a given input is also non-deterministic. An application such as linear classifier or neural network that processes the non-deterministic output from the recurrent neural network will have a built-in tolerance to variability.

For the sake of completeness, a single recurrent neural network need not possess all of these characteristic simultaneously in order to have an improved robustness. Rather, a combination of these characteristics or even individual one of such characteristics can improve robustness to some extent.

FIG. 3 is schematic representation of another minute portion 300 of a recurrent neural network. Portion 300 includes a mere four nodes 305, 310, 315, 320. Nodes 305, 310, 315, 320 are interconnected by a collection of links. Further nodes 305, 310, 315, 320 are connected to other nodes in the recurrent neural network by additional links. For illustrative purposes, those additional links are represented as dashed lines.

Portion 300 can achieve many of the same characteristics that can improve robustness as schematically illustrated in portion 200 (FIG. 2), albeit in a different manner.

For example, in portion 300, a large fan-out and/or fan-in can be the consequence of links that embody at least some of the morphological and other characteristics of biological neurons. For example, links can embody characteristics of chemical synapses and electrical synapses between dendrite-like links and axon-like links. As another example, links can embody at least some of the morphological and other characteristics of dendro-dendritic connections and represent a continuous and immediate connection between nodes.

Further, dendrite-like branches can form multi-link connections between individual nodes. For example, in encircled region 325, dendrite-like branches off of a stem from node 305 can form numerous connections with dendrite-like branches off of a stem that extends between node 315, 320. In general, dendrite-like branches and other multi-link connections will not convey the exact same information in the exact same manner. Variability can be achieved in a variety of different ways. For example, some multi-link connections may react to excitatory signals with an inhibitory response. Other multi-link connections may react to inhibitory signals with an excitatory response. Different dendrite-like branches may have different transmission times and amplitude attenuations. The contacts between different dendrite-like branches can also have different characteristics. For example, in recurrent neural networks that model the characteristics of a biological system, different contacts can model different degrees of the morphological and chemical characteristics of different synapses. This is also true of the links themselves. For example, all or only a portion of some links can be modeled as cables. In other instances, all or only a portion of one or more links and/or the connections between links can convey information in accordance with a mathematical expression that models biological and even non-biological characteristics.

Portion 300 can also display non-deterministic transmission between individual nodes. As the number of parameters in portion 300 increases, so do options for introducing non-deterministic transmission.

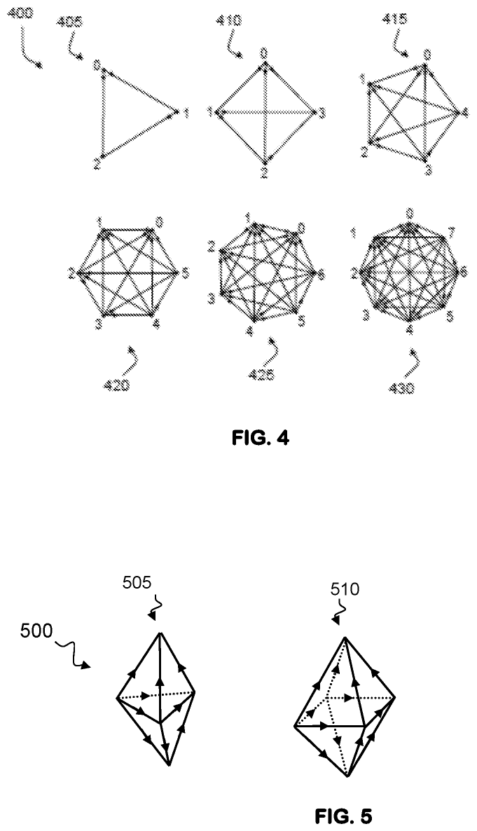

FIG. 4 is a representation of patterns 400 of activity that can be identified and “read” to generate collection 120 from neural network 110 (FIG. 1).

Patterns 400 are representations of activity within a recurrent artificial neural network. To read patterns 400, a functional graph is treated as a topological space with nodes as points. Activity in nodes and links that comports with patterns 400 can be recognized as ordered regardless of the identity of the particular nodes and/or links that participate in the activity. In the illustrated implementation, patterns 400 are all directed cliques or directed simplices. In such patterns, activity originates from a source node that transmits signals to every other node in the pattern. In patterns 400, such source nodes are designated as point 0 whereas the other nodes are designated as points 1, 2, . . . . Further, in directed cliques or simplices, one of the nodes acts a sink and receives signals transmitted from every other node in the pattern. In patterns 400, such sink nodes are designated as the highest numbered point in the pattern. For example, in pattern 405, the sink node is designated as point 2. In pattern 410, the sink node is designated as point 3. In pattern 415, the sink node is designated as point 3, and so on. The activity represented by patterns 400 is thus ordered in a distinguishable manner.

Each of patterns 400 has a different number of points and reflects ordered activity in a different number of nodes. For example, pattern 405 is a 2D-simplex and reflects activity in three nodes, pattern 410 is a 3D-simplex and reflects activity in four nodes, and so on. As the number of points in a pattern increases, so does the degree of ordering and the complexity of the activity. For example, for a large collection of nodes that have a certain level of random activity within a window, some of that activity may comport with pattern 405 out of happenstance. However, it is progressively more unlikely that random activity will comport with the respective of patterns 410, 415, 420. . . . The presence of activity that comports with pattern 430 is thus indicative of a relatively higher degree of ordering and complexity in the activity that the presence of activity that comports with pattern 405.

Different duration windows can be defined for different determinations of the complexity of activity. For example, when activity that comports with pattern 430 is to be identified, longer duration windows can be used than when activity that comports with pattern 405 is to be identified.

FIG. 5 is a representation of patterns 500 of activity that can be identified and “read” to generate binary digit collection 120 from neural network 110 (FIG. 1).

Patterns 500 are groups of directed cliques or directed simplices of the same dimension (i.e., have the same number of points) that define patterns involving more points than the individual cliques or simplices and enclose cavities within the group of directed simplices.

By way of example, pattern 505 includes six different three point, 2-dimensions patterns 405 that together define a homology class of degree two, whereas pattern 510 includes eight different three point, 2-dimensions patterns 405 that together define a second homology class of degree two. Each of the three point, 2-dimensions patterns 405 in patterns 505, 510 can be thought of as enclosing a respective cavity. The nth Betti number associated with a directed graph provides a count of such homology classes within a topological representation.

The activity represented by patterns such as patterns 500 represents a relatively high degree of ordering of the activity within a network that is unlikely to arise by random happenstance. Patterns 500 can be used to characterize the complexity of that activity.

In some implementations, only some patterns of activity are identified and/or some portion of the patterns of activity that are identified are discarded or otherwise ignored. For example, with reference to FIG. 4, activity that comports with the five point, 4-dimensional simplex pattern 415 inherently includes activity that comports with the four point, 3-dimensional and three point, 2-dimension simplex patterns 410, 405. For example, points 0, 2, 3, 4 and points 1, 2, 3, 4 in 4-dimensional simplex pattern 415 of FIG. 4 both comport with 3-dimensional simplex pattern 410. In some implementations, patterns that include fewer points—and hence are of a lower dimension—can be discarded or otherwise ignored. As another example, only some patterns of activity need be identified. For example, in some implementations only patterns with odd number of points (3, 5, 7, . . . ) or even numbers of dimensions (2, 4, 6, . . . ) are identified. Notwithstanding the identification of only some patterns, information about the activity in the neural network can nevertheless be holographically represented, i.e., at lower resolution that if all patterns of identified and/or represented in an output.

As discussed above, the patterns of activity that are responsive to input data represent a specific operation of arbitrary complexity performed by the neural network 110 on that input data. In some implementations, the complexity of the operation will be reflected in the complexity of the topological pattern. For example, the operation or abstraction represented by the five point, 4-dimensional simplex pattern 415 may be more complex than the operations or abstractions represented by the four point, 3-dimensional and three point, 2-dimension simplex patterns 410, 405. In such cases, digits that represent the presence of activity convey that a set operations or abstractions is performed in neural network 110, where each of these operations or abstractions has an arbitrary level of complexity.

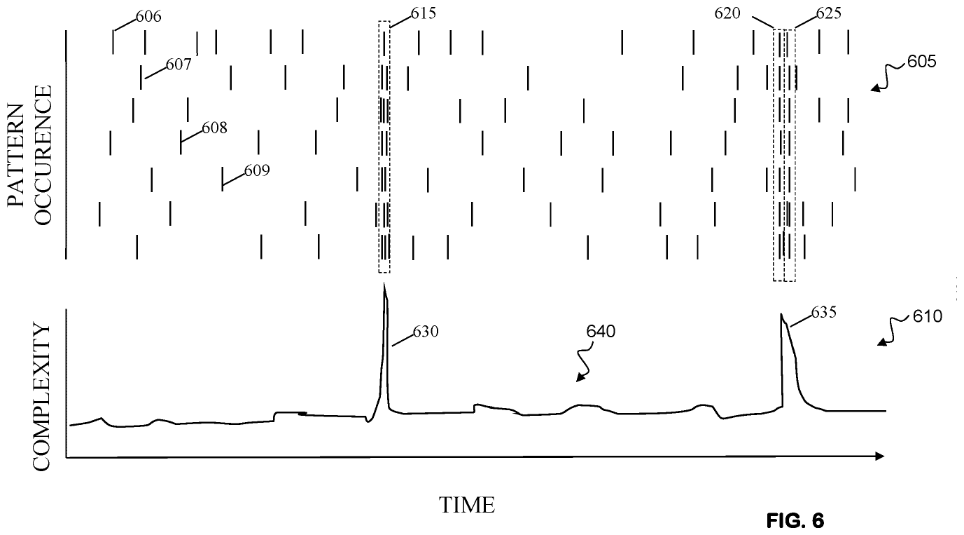

FIG. 6 is a schematic representation of a determination of the timing of activity patterns that have a distinguishable complexity. The determination represented in FIG. 6 can be performed as part of an identification or “reading” of patterns of activity to generate digit collection 120 from neural network 110 (FIG. 1).

FIG. 6 includes a graph 605 and a graph 610. Graph 605 represents occurrences of patterns as a function of time along the x-axis. In particular, individual occurrences are represented schematically as vertical lines 606, 607, 608, 609. Each row of occurrences can be instances where activity matches a respective pattern or class of pattern. For example, the top row of occurrences can be instances where activity matches pattern 405 (FIG. 4), the second row of occurrences can be instances where activity matches pattern 410 (FIG. 4), the third row of occurrences can be instances where activity matches pattern 415 (FIG. 4), and so on.

Graph 605 also includes dashed rectangles 615, 620, 625 that schematically delineate different windows of time when the activity patterns have a distinguishable complexity. As shown, the likelihood that activity in the recurrent artificial neural network matches a pattern indicative of complexity is higher during the windows delineated by dashed rectangles 615, 620, 625 than outside those windows.

Graph 610 represents the complexity associated with these occurrences as a function of time along the x-axis. Graph 610 includes a first peak 630 in complexity that coincides with the window delineated by dashed rectangle 615 and a second peak 635 in complexity that coincides with the window delineated by dashed rectangles 620, 625. As shown, the complexity represented by peaks 630, 635 is distinguishable from what can be considered to be a baseline level 640 of complexity.

In some implementations, the times at which the output of a recurrent artificial neural network is to be read coincide with the occurrences of activity patterns that have a distinguishable complexity. For example, in the illustrative context of FIG. 6, the output of a recurrent artificial neural network can be read at peaks 630, 635, i.e., during the windows delineated by dashed rectangles 615, 620, 625.

In some implementations, not only the content but also the timing of the activity patterns that have a distinguishable complexity can be output from the recurrent artificial neural network. In particular, not only the identity and activity of the nodes that participate in activity that comports with the activity patterns, but also the timing of the activity patterns can be considered the output of the recurrent artificial neural network. The identified activity patterns as well as the timing when this decision is to be read can thus represent the result of processing by the neural network.

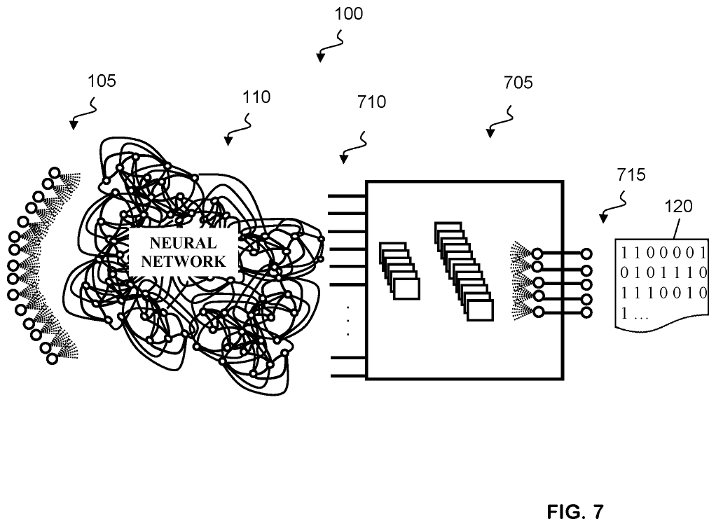

FIG. 7 is a schematic representation of an implementation of a relatively robust artificial neural network system 700. In addition to network inputs 105 and recurrent neural network 110, neural network system 700 also includes graph convolutional neural network 705 that is coupled to read the topological patterns that arise in recurrent neural network 110.

A graph convolutional neural network is a neural network that operates on graphs. Graph convolutional neural network 705 includes a collection of inputs 710 and outputs 715. At inputs 710, graph convolutional neural network 705 can receive representation of the graph structure in a recurrent neural network 110 and a feature matrix for each node in recurrent neural network 110 that represents activity at each node. Graph convolutional neural network 705 can extract topological patterns in the activity such as shown in FIGS. 4, 5 and output a representation of the occurrence of the topological patterns over outputs 715.

By using a graph convolutional neural network to read the topological patterns that arise in recurrent neural network 110, robustness can be improved. In particular, in contrast with convolutional neural networks that process images and are resistant to noise because of their reliance upon spatial continuity within the image, graph convolutional neural networks can rely upon other metrics to resist noise. For example, similar or “neighboring” nodes in the graph of recurrent neural network 110 can be identified according to, e.g., the similarity of their response to an input. The receptive fields of the nodes in the graph convolutional neural network can include portions of more than one such similar or neighboring node. Blurring layers can blur the activity levels of such similar or neighboring nodes. Once again, any particular fault—be it in the input data or the nodes and links within the recurrent neural network itself—is unlikely to lead to catastrophic failure.

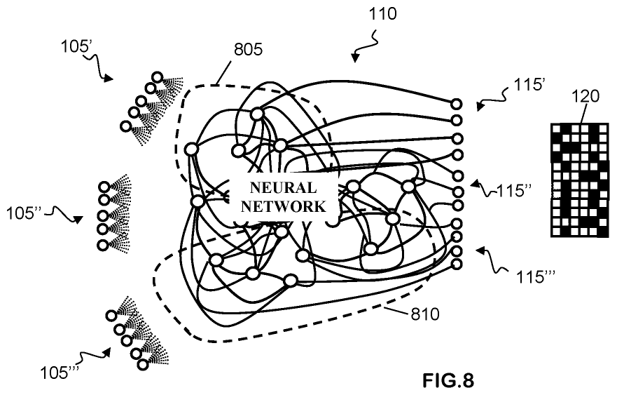

FIG. 8 is a schematic representation of an approach for inputting data that originates from different sensors into neural network 110. In the illustrated implementation, different subsets 105′, 105″, 105′″ of network inputs 105 are dedicated to receiving different types of input data. For example, a first subset 105′ can be dedicated to receiving a first class of input data (e.g., data that originates from a first sensor or transducer) whereas a second subset 105″ can be dedicated to receiving a second class of input data (e.g., data that originates from a second sensor or transducer). In some implementations, corresponding “regions” 805, 810 of neural network 110 receive different classes of input data from different subsets 105′, 105″, 105′″ of network inputs 105. For example, in the schematic illustration, regions 805, 810 are shown spatially discrete collections of nodes and edges with relatively few node-to-node connections between each region. This is not necessarily the case. Rather, the nodes and edges of each region 805, 810 can be spatially distributed within neural network 110 but yet receive a particular class of input data.

Regardless the distribution of the nodes in each region 805, 810, the processing in each region 805, 810 is primarily—but not necessarily exclusively—perturbed by the respectively received class of input data. The extent of perturbation can be measured based on the activity that occurs in a region with and without the respective class of input data being present. For example, a region that is primarily perturbed by a first class of input data may respond to the first class of input data in generally the same manner regardless of whether other classes of input data perturb network 110 at the same time. The processing and abstractions performed by each region 805, 810 are primarily influenced by the received class of input data. Nevertheless, the topological patterns of activity that arise in each region 805, 810 can be read as a digit collection 120. The same is true for other regions of recurrent neural network 110.

This schematically represented in neural network system by separately designating different subsets 115′, 115″, 115′″ of network outputs 115. In particular, subset 115′ can be dedicated to outputting digits that represent topological patterns of activity that arise in region 805 of neural network 110, whereas subset 115′″ can be dedicated to outputting digits that represent topological patterns of activity that arise in region 810 of neural network 110. However, subset 115″ outputs digits that are not found in either of regions 805, 810. Indeed, the digits that are output in subset 115″ may represent a fusion or further abstraction of the abstract representations and processing results that arise in regions 805, 810 to a higher level of complexity.

For example, a given digit in subset 115″ may arise if and only if both one or more digits in subset 115′ and one or more digit in subset 115′″ have certain values. The digit in subset 115″ can thus represent an arbitrarily higher level abstraction—both of the abstractions generated in regions 805, 810 but also of the input data itself.

When different regions are primarily perturbed by a single class of input data, the processing in those regions can be tailored to the nature of the input data. For example, the depth of connection and the topology of network loops can be tailored to the input data. In recurrent neural networks that are modelled on biological systems, neuronal dynamics and synaptic plasticity can also be tailored to the input data. The tailoring, e.g., capture different time scales. For example, the processing in a region that is tailored to processing classes of input data that changes relatively rapidly (e.g., video or audio data) can be faster than the processing in a region that is tailored to processing classes of input data that changes relatively slowly or not at all.

Further, when different regions of a recurrent neural network are primarily perturbed by a single class of input data and the results of the processing in different regions is subsequently fused, the robustness of the processing in the recurrent neural network can be improved. In particular, the relatively low-level processing performed on individual classes of input data can yield representations that are generally applicable in different contexts, i.e., representations that are more “universal” than the representations which would be generated in a highly trained neural network.

Such generally applicable representations tend to be more robust than higher level representations. For example, in the context of image processing, representations of concepts like “orientation” and “color” may be more robust and noise- or fault-resistant than higher-level categorizations like “dog” or “cat.”

Further, because recurrent neural network 110 can fuse the low-level representations of input data from diverse sensors, even the higher-level representations are more robust. Neutral network 110 is not exclusively reliant on any one type of data being correct and faulty input can be fused with other, accurate input data.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations have been described. Nevertheless, it will be understood that various modifications may be made. Accordingly, other implementations are within the scope of the following claims.

What is claimed is:

1. A system comprising:
a plurality of nodes and links arranged in a recurrent neural network, wherein either transmissions of information along the links or decisions at the nodes are non-deterministic; and
an output configured to output indications of occurrences of topological patterns of activity in the recurrent artificial neural network.

2. The system of claim 1, wherein decision thresholds of the nodes have a degree of randomness.

3. The system of claim 1, wherein the recurrent neural network includes background activity that is not dependent on input data.

4. The system of claim 1, wherein either a timing of signal arrival at a destination node or a signal amplitude at the destination node has the degree of randomness.

5. The system of claim 1, wherein at least some pairs of nodes are linked by multiple links.

6. The system of claim 1, further comprising an application trained to process the indications of the occurrences of topological patterns of activity, wherein the application is trained using non-deterministic output from the recurrent artificial neural network.

7. The system of claim 1, wherein the topological patterns of activity are clique patterns of activity.

8. A system comprising:
a plurality of nodes and links arranged in a recurrent neural network, wherein each node is coupled to output signals to between 10 and 10\hat{ }6 other nodes and to receive signals from between 10 and 10\hat{ }6 other nodes; and
an output configured to output indications of occurrences of topological patterns of activity in the recurrent artificial neural network.

9. The system of claim 8, wherein each node is coupled to output signals to between 10\hat{ }3 and 10\hat{ }5 other nodes and to receive signals from between 10\hat{ }3 and 10\hat{ }5 other nodes.

10. The system of claim 8, wherein each of the links is configured to convey information that is encoded in a number of nearly identical signals transmitted within a given time.

11. The system of claim 8, wherein transmission of information along the links is non-deterministic.

12. The system of claim 8, wherein at least some pairs of nodes are linked by multiple links.

13. The system of claim 8, wherein the topological patterns of activity are clique patterns of activity.

14. A system comprising:
a plurality of nodes and links arranged in a recurrent neural network, wherein at least some pairs of nodes are linked by multiple connections; and
an output configured to output indications of occurrences of topological patterns of activity in the recurrent artificial neural network.

15. The system of claim 14, wherein the multiple connections comprise multiple excitatory links.

16. The system of claim 15, wherein the multiple excitatory links comprise between 2 and 20 excitatory links.

17. The system of claim 14, wherein the multiple connections comprise multiple inhibitory links.

18. The system of claim 17, wherein the multiple inhibitory links comprise between 5 and 40 links.

19. The system of claim 14, wherein the multiple connections are configured to convey a same signal but ensure that the signal arrives at a destination node at different times.

20. The system of claim 14, wherein the multiple connections are configured to convey a same signal but with a degree of randomness in the conveyance of the signal.

21. The system of claim 20, wherein either a timing of signal arrival at a destination node or a signal amplitude at the destination node has the degree of randomness.

22. The system of claim 14, wherein the multiple connections comprise a single link that conveys information in accordance with a model of multiple links.

23. The system of claim 14, wherein the topological patterns of activity are clique patterns of activity.

24. A system comprising:
a plurality of nodes and links arranged in a recurrent neural network, wherein the recurrent neural network includes background activity that is not dependent on input data; and
an output configured to output indications of occurrences of topological patterns of activity in the recurrent artificial neural network.

25. The system of claim 24, wherein either transmissions of information along the links or decisions at the nodes are non-deterministic.

26. The system of claim 24, wherein at least some pairs of nodes are linked by multiple connections.

27. The system of claim 26, wherein the multiple connections comprise between 3 and 10 links excitatory links.

28. The system of claim 26, wherein the multiple connections comprise between 10 and 30 inhibitory links.

29. The system of claim 24, wherein each node is coupled to output signals to between 10\hat{ }3 and 10\hat{ }5 other nodes and to receive signals from between 10\hat{ }3 and 10\hat{ }5 other nodes.

30. The system of claim 24, wherein the topological patterns of activity are clique patterns of activity.
